(19) United States
(12) Patent Application Publication
(10) Pub. No.: US 2015/0295854 A1
(43) Pub. Date: Oct. 15, 2015

(54) RESOURCE MANAGEMENT SYSTEM, RESOURCE MANAGEMENT METHOD AND PROGRAM

(71) Applicants: Wei SUN, (US); NEC CORPORATION, Minato-ku, Tokyo (JP)

(72) Inventor: Wei Sun, Tokyo (JP)

(73) Assignee: NEC CORPORATION, Tokyo (JP)

(21) Appl. No.: 14/442,959

(22) PCT Filed: Nov. 16, 2012
(86) PCT No.: PCT/JP2012/007383

§ 371 Date: May 14, 2015

(51) Int. Cl. H04L 12/911; H04L 29/08

(52) U.S. Cl. CPC H04L 47/821; H04L 67/10

(57) ABSTRACT

A resource management system for cloud computing, comprises: critical time table that stores earliest and latest deadlines for jobs of each of plurality of types in association with classification code for the type; worst case execution time (WCET) table that stores WCET for jobs of each of plurality of types in association with classification code for the type; classification unit that classifies job from user into one of plurality of types and associates job with classification code for the type; and core unit that determines earliest and latest deadlines and WCET for the classified job based, respectively, on critical time table and WCET table, and generates schedule for classified job in accordance with determined earliest and latest deadlines and the determined WCET.

### TECHNICAL FIELD

This application is a National Stage Entry of International Application No. PCT/JP2012/007383, filed Nov. 16, 2012. The present invention relates to a resource management system, resource management method, and program, and especially to a resource management system, resource management method and program that provide a real-time cloud service.

### BACKGROUND

Most of techniques for real-time systems assume that many features of a given system are known beforehand. For example, periodic task systems assume a job release time, worst case execution time (WCET), implicit or explicit deadline (NPL 1). Both sporadic task system and aperiodic task system mitigate an assumption on job release time (NPLs 1, 2). Soft-real-time systems allow that deadlines are not guaranteed fully provided that performance and reliability are not jeopardized greatly (NPLs 3, 4). Some techniques have been proposed that adjust task periods or control aftermath of delaying deadlines (NPLs 5, 6). NPL 6 describes an elastic task model, in which task's periods are treated as springs with given elastic coefficients. However, it is necessary to know task attributes, and tasks are not schedulable when enough resources are not available.

A cloud computing system provides resource augmentation by virtualization techniques (NPLs 7, 8), in which there are some new features not present in the conventional computer systems. For example, it is easy to employ more physical resources, deploy applications and change system configurations in the cloud computer system. Different from the conventional computer systems, to move a running object in the virtual world often refers to move a virtual machine including the running object as a whole.

### NPL 1:

J. Carpenter, et al., “A Categorization of Real-Time Multiprocessor Scheduling Problems and Algorithms,” J. Y-T. Leung eds. Handbook of Scheduling: Algorithms, Models and Performance Analysis, CRC Press, 2004.

### NPL 2:

N. W. Fisher, “The Multiprocessor Real-Time Scheduling of General Task Systems,” Doctoral Dissertation, University of North Carolina at Chapel Hill, 2007.

### NPL 3:

J. W. S. Liu, W. K. Shih, K. J. Lin, R. Bettati and J. Y. Chung, “Imprecise Computations,” Proc. IEEE, vol. 82, no. 1, pp. 83-94, January 1994.

### NPL 4:

U. C. Devi, “Soft Real-Time Scheduling on Multiprocessor,” Doctoral Dissertation, University of North Carolina at Chapel Hill, 2006.

### NPL 5:

T. Chantem, X. S. Hu, and M. D. Lemmon, “Generalized Elastic Scheduling for Real-Time Tasks,” IEEE Transactions on Computers, vol. 58, no. 4, pp. 480-495, April 2009.

### NPL 6:

G. Buttazzo, G. Lipari, and L. Abeni, “Elastic Task Model for Adaptive Rate Control,” Proc. 26th IEEE Real-Time Systems Symp. pp. 399-409, 2005.

### NPL 7:

B. Hayes, “Cloud Computing,” Communication of the ACM, vol. 51, no. 7, pp. 9-11, 2008.

### NPL 8:

M. Armbrust, A. Fox, R. Griffith, et al., “A View of Cloud Computing,” Communication of the ACM, vol. 53, no. 4, pp. 50-58, 2010.

### SUMMARY

The entire disclosures of the above mentioned Non-Patent Literatures are incorporated herein by reference thereto. The following analyses are given by the present invention.

More and more applications and services in clouds tend to be real-time. However, most of them are too general without knowing many features beforehand. User request arrival time and service time are not easily and accurately represented by conventional models. It is hard to define the maximum response time, i.e. deadlines for a large number of applications, not to mention trivial operations. Although datacenters have plenty of resources and resource augmentation can meet the increasing resource requirements, resource elastic should be in control to avoid unnecessary cost. Moreover, no elastic has been provided to both user end and resource end and hence there is no coordinated elastic on the two ends.

Many services running on clouds are required to be “real-time.” In order to realize real-time cloud services, some technical problems are itemized as follows.

1. Not all user requests have clearly defined time requirements. A problem is how to decide time requirement for each user request in practice.

2. For many services, whether they are real-time or not depends on user experience. Usually, user experience is not so keen to time delays as compared with controlled objects in control systems. A problem is to what extent a user request can be delayed and which user request should be delayed.

3. Even the same user requests may have different time requirements at different time points and social or natural events. A problem is how to decide time requirements in a smart way to perceive the change of situations.

4. Not all execution times of operations can be known exactly beforehand. For example, retrieving different users' data may be quite different. Moreover, sometimes it is better to know the worst case execution time (WCET) of a set of operations. For example, an operation “A” for Alice to read her user data needs 5 seconds and an operation “B” for Bob to read his user data needs 8 seconds, since Bob uploads photographs but Alice does not. In this case, 8 seconds is the maximum time between Alice and Bob. A problem is how to know the WCET properly for a set of operation (or jobs).

5. Existing deadline selection techniques only work on task level rather than job level and hence are rigid to handle plenty of different jobs with less defined deadlines. Moreover, they do not take into account the elastic on resources on relaxing deadlines. The problem related to that needs a sophisticated method to handle plenty of time constrained user requests and coordinate the elastic on both user and resource ends.

Therefore, there is a need in the art to achieve real-time execution of a job that has no clearly defined time requirement.

According to a first aspect of the present disclosure, there is provided a resource management system for cloud computing, comprising:

a critical time table that stores earliest and latest deadlines for jobs of each type in association with a classification code for the type;
a worst case execution time (WCET) table that stores a WCET for jobs of each type in association with a classification code for the type;
a classification unit that classifies a job from a user into one of a plurality of types and associates the job with a classification code for the type; and
a core unit that determines earliest and latest deadlines and a WCET for the classified job based, respectively, on the critical time table and the WCET table, and generates a schedule for the classified job in accordance with the determined earliest and latest deadlines and the determined WCET.

According to a second aspect of the present disclosure, there is provided a resource management method for cloud computing, comprising:

by a computer, storing earliest and latest deadlines for jobs of each of a plurality of types in association with a classification code for the type in a critical time table;
storing a worst case execution time (WCET) for jobs of each of the plurality of type in association with a classification code for the type in a WCET table;
classifying a job from a user into one of the plurality of types;
associating the job with a classification code for the type;
determining earliest and latest deadlines and a WCET for the classified job based, respectively, on the critical time table and the WCET table; and
generating a schedule for the classified job in accordance with the determined earliest and latest deadlines and the determined WCET.

According to a third aspect of the present disclosure, there is provided a program that causes a computer to execute:

storing earliest and latest deadlines for jobs of each of a plurality of types in association with a classification code for the type in a critical time table;
storing a worst case execution time (WCET) for jobs of each of the plurality of types in association with a classification code for the type in a WCET table;
classifying a job from a user into one of the plurality of types;
associating the job with a classification code for the type;
determining earliest and latest deadlines and a WCET for the classified job based, respectively, on the critical time table and the WCET table; and
generating a schedule for the classified job in accordance with the determined earliest and latest deadlines and the determined WCET.

The present invention provides the following advantage, but not restricted thereto. The resource management system, resource management method and program according to the present disclosure contribute to a need to achieve real-time execution of a job that has no clearly defined time requirement.

### BRIEF DESCRIPTION OF THE DRAWINGS

FIG. 1 illustrates an example of a structure of a resource management system according to an exemplary embodiment;

FIG. 2 illustrates an example of keyword tables and classification table for a classification unit in the resource management system according to the exemplary embodiment;

FIG. 3 illustrates an example of a hierarchical graph for a classification unit in the resource management system according to the exemplary embodiment;

FIG. 4 illustrates an example of a ranking table for a perception unit in the resource management system according to the exemplary embodiment;

FIG. 5 illustrates an example of a WCET table in the resource management system according to the exemplary embodiment;

FIG. 6 illustrates an example of a critical time table in the resource management system according to the exemplary embodiment; and

FIG. 7 illustrates an example of a pseudocode for a core unit in the resource management system according to the exemplary embodiment.

### PREFERRED MODES

In the present disclosure, there are various possible modes, which include the following, but not restricted thereto. Preferred modes will be described herein below as exemplary embodiments.

### Exemplary Embodiment

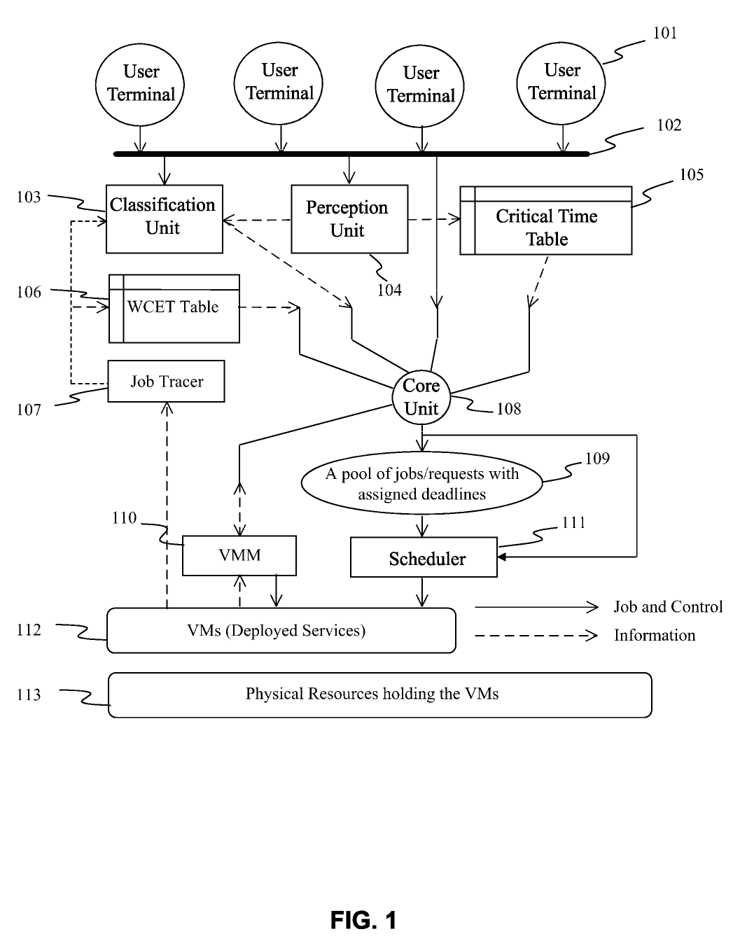

FIG. 1 illustrates an example of a structure of a resource management system according to an exemplary embodiment. The resource management system provides a real-time cloud service. With reference to FIG. 1, the resource management system comprises a classification unit 103, a perception unit 104, a critical time table 105, a worst case execution time (WCET) table 106, a job tracer 107, a core unit 108, a virtual machine monitor (VMM) 110, a scheduler 111 and virtual machines (VMs) 112.

User terminals 101 are connected to the resource management system though a communication network 102. Each user terminal 101 sends requests to the resource management system. Hereinafter, for simplicity, we use terms request and job interchangeably.

The classification unit 103 and the perception unit 104 acquire information on jobs. The classification unit 103 classifies the jobs to check whether or not each job belongs to the existing types. Then each job will be assigned a classification code if it exists. The perception unit 104 perceives the history of jobs and users to identify the change in user behaviors. The critical time table 105 stores some default time requirements for typical operations. Later, how to perceive user behaviors and critical times are described in detail. The perception unit 104 affects the classification in the classification unit 103 and the critical time table 105 to adapt to the change of situations.

The WCET table 106 documents WCETs. A specific user request is not associated with a WCET. Instead, each type of request is given a WCET. Only if the grain in the classification of the classification unit 103 is very fine to just capture the exact user request, the WCET of a type is completely that of a user request.

The core unit 108 receives information of jobs from the classification unit 103, the critical time table 105, the WCET table 106 and the VMM 110. Then the core unit 108 does the following: 1) match each job to a type and find the proper WCET; 2) in terms of the critical time table 105, decide the suitable deadline for each job; 3) compute a schedule of jobs with coordinated elastic on deadlines and resources; 4) notice the VMM 110 to activate new VMs or release existing VMs; 5) create a pool of jobs with defined deadlines 109; 6) transfer the schedule to a scheduler 111. The entities of jobs are stored in the pool 109.

The scheduler 111 selects some jobs to run in VMs in terms of the computed schedule. This can be modeled as a multiprocessor system with a central queue. The VMM 110 manages all VMs 112, creates new VMs and also releases idle physical resources 113. Note that, two events are in parallel, the one adjusting VMs and the other preparing jobs into 109. The job tracer 107 traces each running job. When a job is finished, some entries in the classification unit 103 and the WCET table 106 may be modified.

In the following, the details of the resource management system are described with reference to the drawings.

In the present exemplary embodiment, it is not necessary to explicitly define the time attributes (for example, time requirement) of user requests. In practice, in most services the time attributes are not available. Each user request (or job) must be associated with some information, for example, user information, network information, requested data or operations, and some special resources and so on. The classification unit 103 classifies the jobs in terms of the different types of information.

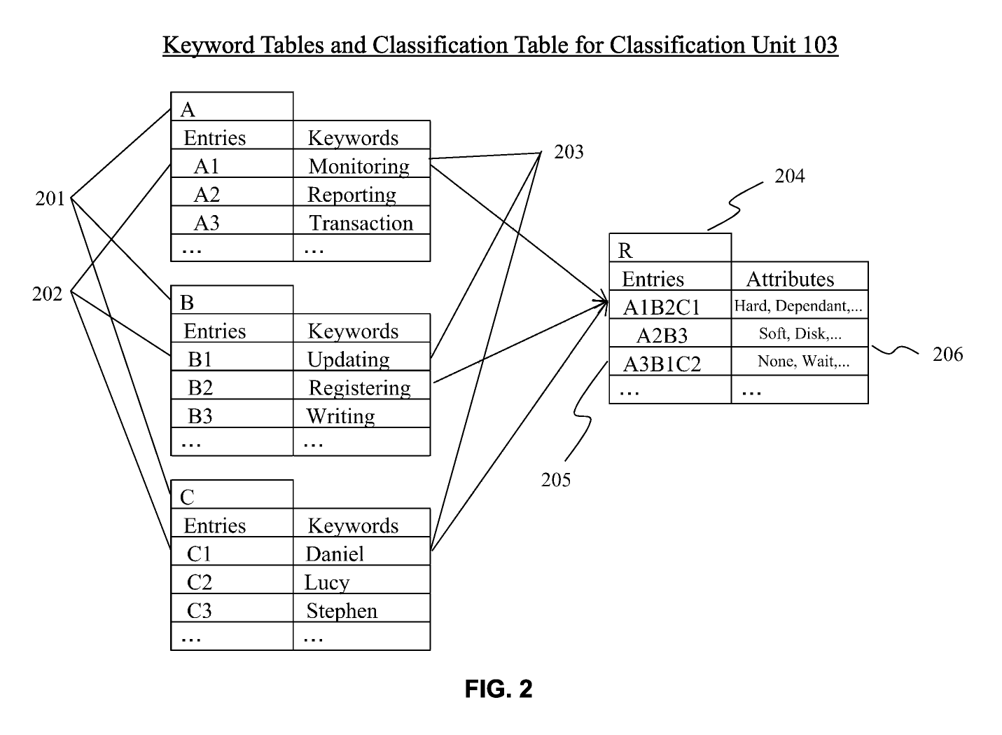

The classification unit 103 may consult keyword tables and a classification table. FIG. 2 illustrate, as an example, keyword tables and a classification table.

With reference to FIG. 2, keyword table A stores applications, keyword table B stores operations, and keyword table C stores user names. In keyword tables A, B and C, each entry 202 denotes a specific feature. A classification table 204 can be built based on these keyword tables A, B and C. Note that these tables are dynamic rather than static. When a new application, operation, or data item appears, new entries may be added to these tables. On the contrary, when the life of an application or data is over, old entries may be deleted from these table.

The classification table 204 documents the various and possible combinations of those entries in the keyword tables A, B and C. A new job's information will be encoded in terms of the entries of the keyword tables A, B and C, and then the entry in the classification table 204 with maximum similarity to the new job's code will be used as the identification of the new job. Each type of jobs has its own attributes 206, for example, a hard-real-time, soft-real-time, or non-real-time, whether it needs some special resources, whether it needs to wait some further events and so on. The attributes may be set explicitly by service providers or (permitted) users.

For example, in a case where a user Daniel registers an application of monitoring some system behaviors and he is a system administrator, the job is identified to be A1B2C1 with hard-real-time attribute and dependency on another job, for example, user verification.

The classification codes in the classification table 204 are same as those in the critical time table 105 and those in the WCET table 106. Namely, classification codes are also associated with WCETs and critical times.

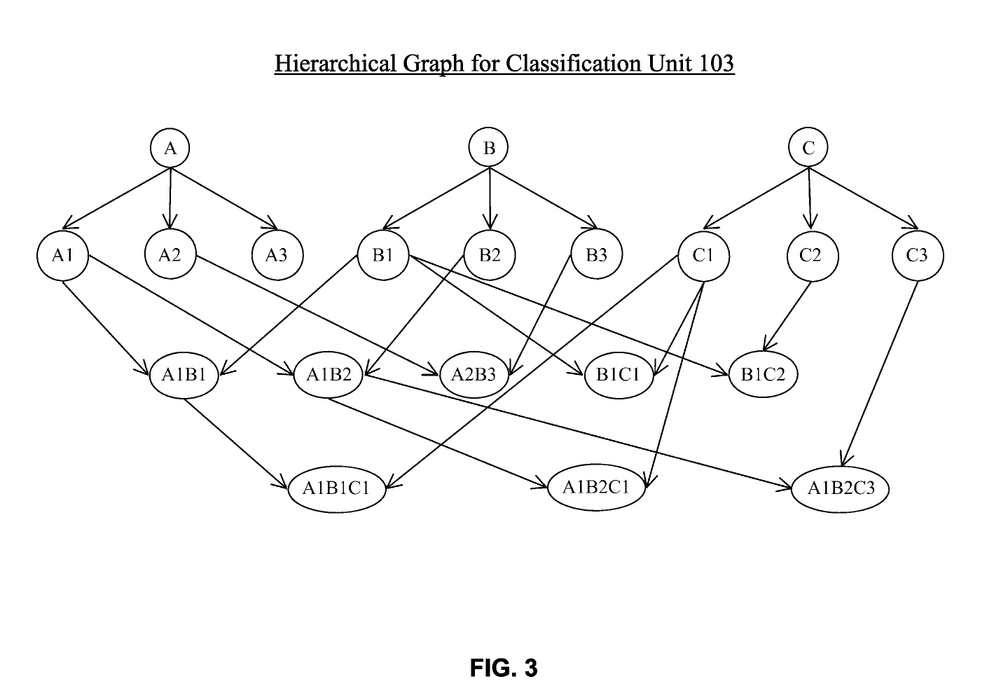

The entries in the keyword tables A, B and C can be organized into a hierarchical graph. In this case, the entries in the classification table 204 correspond to vertices in the hierarchical graph. Deciding the maximum similarity corresponds to finding the vertices at as low level as possible. FIG. 3 illustrates such a hierarchical graph corresponding to the classification table 204 shown in FIG. 2.

The perception unit 104 detects the changes in services. The present exemplary embodiment focuses on the following changes. In runtime, there are many changes supposed to happen. The perception unit 104 aims at only such a case, in which time requirements change implicitly because of the increasing attention paid by users, whereas explicit changes can be captured by the classification unit 103.

An example is given as follows. In a case where a catastrophe, such as an earthquake, happen, many people want to acquire information or data about the disaster. If the requests in such a case are treated equally as other or as before, the services cannot be real-time because user experience changes (users can tolerate much longer waiting time before the catastrophe than they can after the catastrophe). Instead of static detection of intensity, the intensity should be detected timely.

The perception unit 104 may employ a measure of emergence. For each type with the same classification code, the history of jobs is memorized by a moving average (MA) method. Both the sources of requests and the number of accesses within windows of moving-average are recoded. Then, the changes of the data from a moving average are used to evaluate the changes in the physical world.

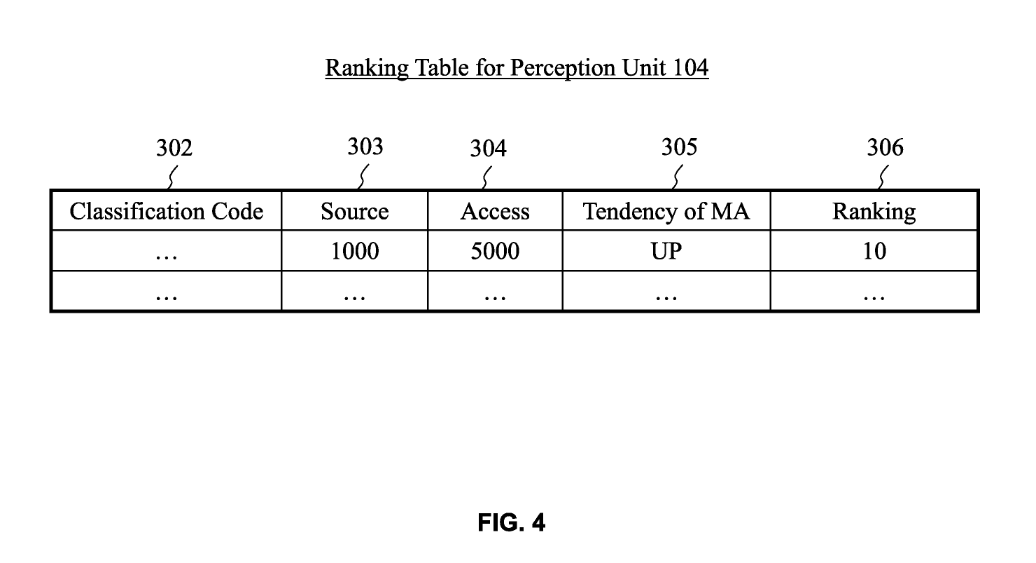

The perception unit 104 may use a ranking table. FIG. 4 illustrates an example of a ranking table for the perception unit 104. With reference to FIG. 4, each entry includes a classification code 302, source 202, access 304, tendency of MA 305, and ranking 306.

Since the classification codes 302 have different lengths, there must be different ranking tables. Which table to be used may be decided by the service provider such that flexibility is supplied. If a general set of operations is hoped to be sensitive, the table with shorter codes should be used, such as reporting disk usage being cared by providers. In this example, the lowest level codes are assumed in the table.

Source 303 designates a user or network address. Access 304 is the number of the requests for the code. A moving average (MA) window, for example, five minutes, is defined by service providers. Sources 303 and accesses 304 are all counted within the window. Compared to the last window for the same code, the tendency of the MA data can be known from the field 305, in comparison with other codes, the ranking 306 can be also known.

The ranking 306 can be used in different ways. For example, a service provider may shorten the deadlines of jobs in the first ten records on computing the schedule in the core unit 108, or shorten the deadlines with different scales for different ranks. Later an exemplar algorithm for the core unit 108 will be shown for the former case, called a binary mark.

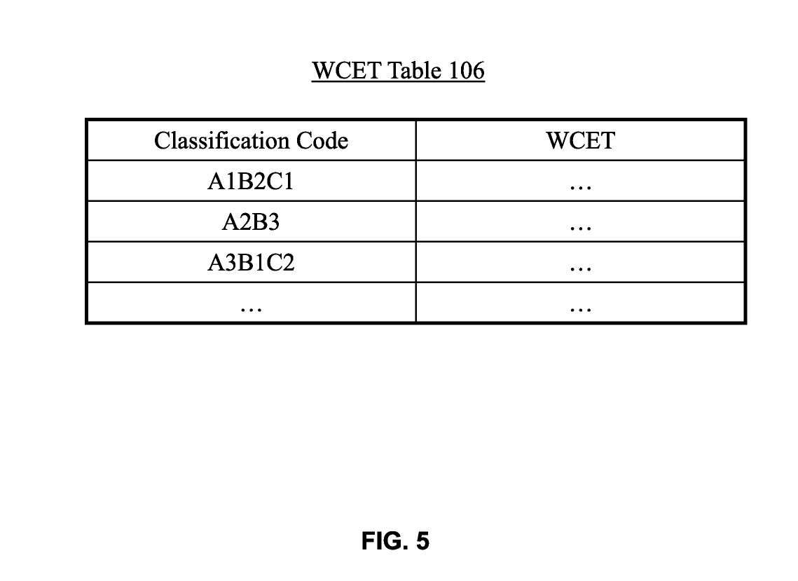

FIG. 5 illustrates an example of the worst case execution time (WCET) table 106. With reference to FIG. 5, the WCET table 106 stores the worst case execution time (WCET) of each type of jobs in association with a classification code for the type. Some of the records in the WCET table 106 can be set up in advance and the others can be registered by the job tracer 107 after execution of jobs.

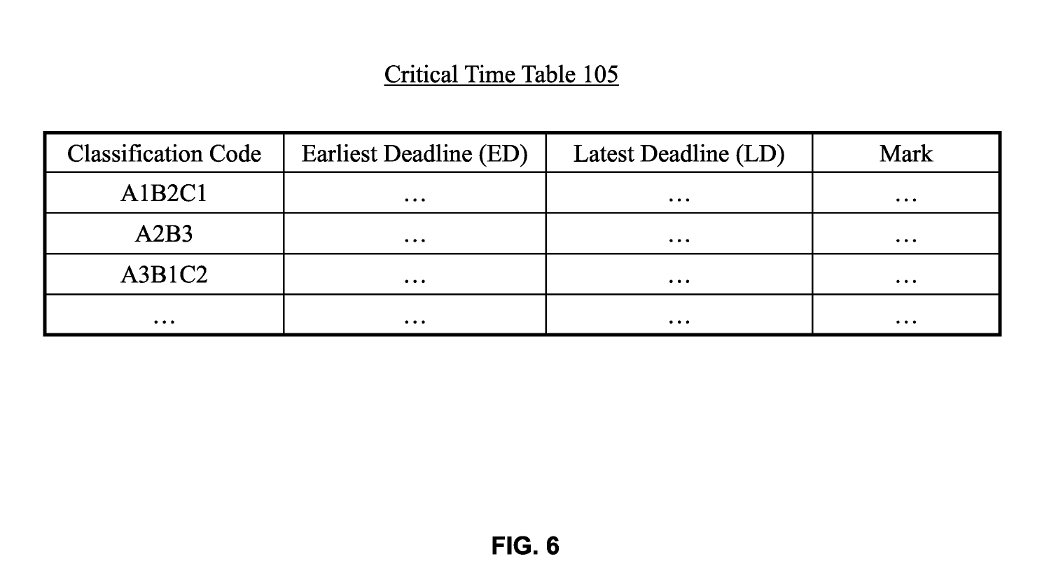

FIG. 6 illustrates an example of the critical time table 105. With reference to FIG. 6, the critical time table 105 stores a critical times (for example, earliest and latest deadlines) for jobs of a type in association with a classification code for the type.

Both the critical time table 105 and the WCET table 106 stores same classification codes, while the data fields are different between these two tables. The data field in the WCET table 106 stores a WCET for each entry (FIG. 5), while the data field in the critical time table 105 stores an earliest deadline (ED), latest deadline (LD), and mark for each entry (FIG. 6).

The resource management system according to the present disclosure is user oriented because both the ED and LD are determined in terms of user experience. As an example, when a user clicks a link in a Web page, the latest response time should not be longer than 4, 8, or 10 seconds according to some reports. Moreover, nobody can distinguish the response time of 0.1 second from 0.5 second obviously. Therefore, ED and LD may be set to be 0.5 second and 10 seconds respectively.

As another example, a frame per second (FPS) in video on demand (VOD) services ranges from 14 to 25, since an FPS lower than 14 will cause significant delay detectable by human and an FPS higher than 25 won't increase user experience obviously. Thus, the ED and LD for VOD can be calculated.

Most EDs and LDs are determined with respect to user experience. Some EDs and LDs may be arbitrarily set by service providers for specific purposes such as improving system performance.

The mark may be given explicitly by service providers or users, or may be given implicitly by the perception unit 104. Two types of marks can be employed: natural number marks or binary marks. The more the count of marks, the finer the services become and more costs are needed as a consequence.

The core unit 108 computes the schedule and determines the elastic on deadlines and resources. The core unit 108 comprises an algorithm, into which the information and data in the classification unit 103 (providing the classification code for each job), the critical time table 105 (providing critical time for each job including ED, LD, and mark), the WCET table 106 (providing WCET for each job), the VMM 110 (providing current VM status), and the jobs themselves are input.

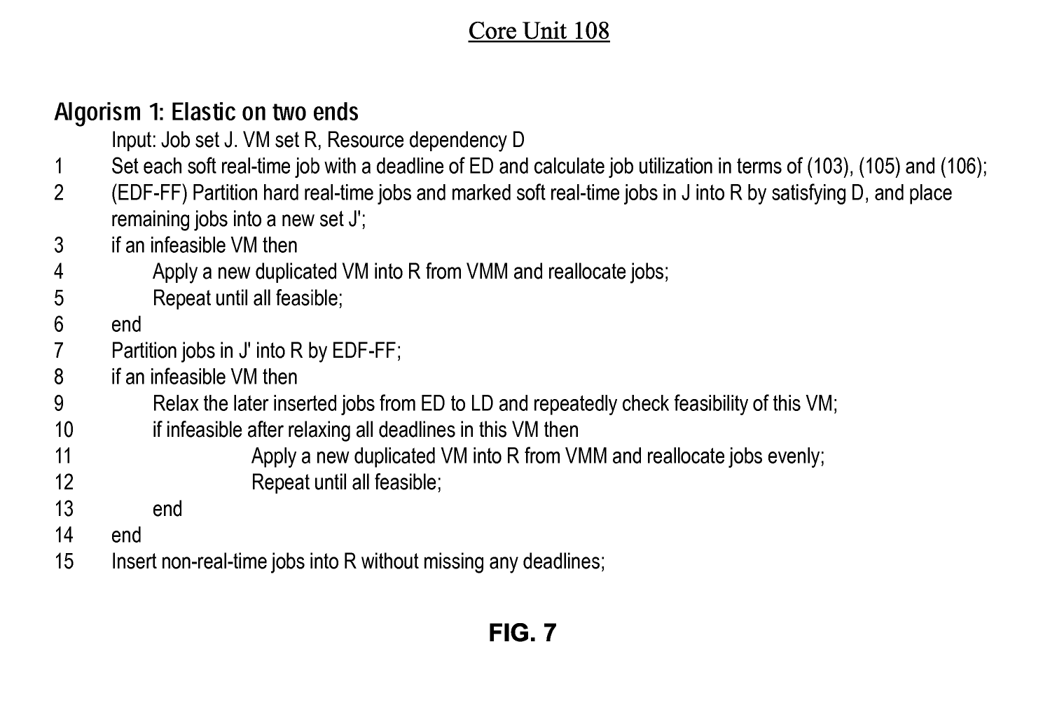

An example of the algorithm is shown in FIG. 7. The example shown in FIG. 7 takes into account binary marks and resource dependency of jobs and the partition algorithm is assumed to be an EDF-FF (Earliest Deadline First-First Fix) algorithm. This algorithm can be modified into other versions by using different marks and partitioning algorithms.

The basic idea of the algorithm shown in FIG. 7 is to split jobs into two sets and then to schedule the two sets in different ways. No deadlines in the first set can be delayed and more VMs are added if any deadline cannot be guaranteed by the partitioning algorithm. Deadlines in the second set can be delayed but the earliest deadlines are tried to be kept, and if and only if LDs are not guaranteed, new VMs are created. Each time when a new VM is required, the algorithm will inquire the VMM 110 to confirm enough resources are available. After the algorithm is executed, a schedule is created and the information of expanding current VMs is also ready.

Then, the jobs are associated with the deadlines in terms of the schedule. Note that the time in the critical time table 105 is not the deadlines but the lower and upper bounds of deadlines. Meanwhile, the schedule is sent to the job scheduler 111 and the information of expanding VMs is sent to the VMM 110. When VMs 112 are prepared, the scheduler 111 dispatches the jobs in terms of the schedule.

To the end of users, the resource management system converts non-real-time services into real-time ones by automatically setting and adjusting proper time constraints on user requests. To the end of resources, the resource management system balances the demand on resources from users and the supply of resources from cloud datacenters. Therefore, the resource management system realizes double-elastic on two ends, users and resources, in a real-time cloud service.

Note that reference signs or numerals referring to the drawings mentioned in the present disclosure are given merely for better illustrative purpose and not intended to limit the present disclosure to the illustrated modes or examples.

The disclosures of the above Non-Patent Literatures are incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.
101 user terminal
102 communication network
103 classification unit
104 perception unit
105 critical time table
106 worst case execution time (WCET) table
107 job tracer
108 core unit
110 virtual machine monitor (VMM)
111 scheduler
112 virtual machines (VMs)
113 physical resources
201 keyword table
202 entry
203 keyword
204 classification table
205 classification code
206 attributes
302 classification code
303 source
304 access
305 tendency of MA
306 ranking

1. A resource management system for cloud computing, comprising:
a critical time table that stores earliest and latest deadlines for jobs of each of a plurality of types in association with a classification code for the type;
a worst case execution time (WCET) table that stores a WCET for jobs of each of the plurality of types in association with a classification code for the type;
a classification unit that classifies a job from a user into one of the plurality of types and associates the job with a classification code for the type; and
a core unit that determines earliest and latest deadlines and a WCET for the classified job based, respectively, on the critical time table and the WCET table, and generates a schedule for the classified job in accordance with the determined earliest and latest deadlines and the determined WCET.

2. The resource management system according to claim 1, comprising:
a classification table that stores an attribute for jobs of each of the plurality of types in association with a classification code for the type, wherein
the classification unit associates the job from the user with a classification code whose attribute in the classification table is similar to an attribute for the job.

3. The resource management system according to claim 1, comprising:
a perception unit that monitors a count of jobs for each of the plurality of types and extracts a type, for which the count of jobs deviates positively from its moving average, from the plurality of types, wherein
the core unit schedules the job from the user preferentially in the schedule if the job is classified into the extracted type by the classification unit.

4. The resource management system according to claim 3, wherein
the core unit shortens the determined earliest and latest deadlines for the job from the user if the job is classified into the extracted type by the classification unit.

5. The resource management system according to claim 1, comprising:
a job tracer that monitors execution times for jobs of each of the plurality of types, and updates a WCET for the type in the WCET table if any one of the execution times exceeds the WCET of the type.

6. A resource management method for cloud computing, comprising:
by a computer, storing earliest and latest deadlines for jobs of each of a plurality of types in association with a classification code for the type in a critical time table;
storing a worst case execution time (WCET) for jobs of each of the plurality of type in association with a classification code for the type in a WCET table;
classifying a job from a user into one of the plurality of types;
associating the job with a classification code for the type;
determining earliest and latest deadlines and a WCET for the classified job based, respectively, on the critical time table and the WCET table; and
generating a schedule for the classified job in accordance with the determined earliest and latest deadlines and the determined WCET.

7. The resource management method according to claim 6, comprising:
storing an attribute for jobs of each type in association with a classification code for the type in a classification table; and
associating the job from the user with a classification code whose attribute in the classification table is similar to an attribute for the job.

8. The resource management method according to claim 6, comprising:
by the computer, monitoring a count of jobs for each of the plurality of types;
extracting a type, for which the count of jobs deviates positively from its moving average, from the plurality of the types; and
scheduling the job from the user preferentially in the schedule if the job is classified into the extracted type.

9. The resource management method according to claim 8, comprising:
by the computer, shortening the determined earliest and latest deadlines for the job from the user if the job is classified into the extracted type.

10. The resource management method according to claim 6, comprising:
by the computer, monitoring execution times for jobs of each of the plurality of types; and
updating a WCET for the type in the WCET table if any one of the execution times exceeds the WCET for the type.

11. A non-transitory computer-readable recording medium storing a program that causes a computer to execute:
storing earliest and latest deadlines for jobs of each of a plurality of types in association with a classification code for the type in a critical time table;
storing a worst case execution time (WCET) for jobs of each of the plurality of types in association with a classification code for the type in a WCET table;
classifying a job from a user into one of the plurality of types;
associating the job with a classification code for the type;
determining earliest and latest deadlines and a WCET for the classified job based, respectively, on the critical time table and the WCET table; and
generating a schedule for the classified job in accordance with the determined earliest and latest deadlines and the determined WCET.

12. The non-transitory computer-readable recording medium according to claim 11, wherein
the program causes the computer to execute:
storing an attribute for jobs of each of the plurality of types in association with a classification code for the type in a classification table; and
associating the job from the user with a classification code whose attribute in the classification table is similar to an attribute for the job.

13. The non-transitory computer-readable recording medium according to claim 11, wherein
the program causes the computer to execute:
monitoring a count of jobs for each of the plurality of types;
extracting a type, for which the count of jobs deviates positively from its moving average, from the plurality of types; and
scheduling the job from the user preferentially in the schedule if the job is classified into the extracted type.

14. The non-transitory computer-readable recording medium according to claim 13, wherein
the program causes the computer to execute:
shortening the determined earliest and latest deadlines for the job from the user if the job is classified into the extracted type.

15. The non-transitory computer-readable recording medium according to claim 11, wherein
the program causes the computer to execute:
monitoring execution times for jobs of each of the plurality of types; and
updating a WCET for the type in the WCET table if any one of the execution times exceeds the WCET for the type.
